(19) United States
(12) Patent Application Publication
(10) Pub. No.: US 2015/0057041 A1
(43) Pub. Date: Feb. 26, 2015

(54) Blind Spectrum Sensing Based on Maximum Correlation Coefficients and use Thereof

(71) Applicant: Nokia Corporation, Espoo (FI)

(72) Inventors: Zhi Qiang Bao, xi'an city (CN); Pei Zhao, xi'an city (CN); Guangyue Lu, xi'an city (CN)

(73) Assignee: Nokia Corporation, Espoo (FI)

(21) Appl. No.: 13/973,344

(22) Filed: Aug. 22, 2013

(51) Int. Cl. H04W 48/16

(52) U.S. Cl. CPC H04W 48/16
USPC 455/515

(57) ABSTRACT

A method includes performing blind spectrum sensing of a frequency band to determine whether a primary user is using the frequency band. The blind spectrum sensing is based at least in part on a comparison between a detection statistic based on a maximum correlation coefficient and a detection threshold based on theoretical computation of a distribution of the detection statistic. The maximum correlation coefficient is for correlations between a plurality of signals corresponding to a plurality of snapshots taken by a cognitive radio of the frequency band and corresponding to a plurality of antennas used by the cognitive radio for taking the snapshots. The method includes determining whether to communicate using the frequency band based on whether the blind spectrum sensing indicates the frequency band is or is not used by the primary user. Apparatus and program products are disclosed.

### TECHNICAL FIELD

This invention relates generally to cognitive radio networks and, more specifically, relates to sensing the presence of primary users in cognitive radio networks.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below at the end of the specification but prior to the claims.

Conventional fixed spectrum-allocation policies lead to low spectrum usage in many frequency bands, and cognitive radio is a promising technology for exploiting the underutilized spectrum in an opportunistic manner.

For a cognitive radio networks (CRNs), terminals trying to communicate need to dynamically detect the presence of primary users (PUs). When PUs do not use frequency bands, the cognitive users (CUs) can access the frequency bands in a dynamic spectrum access (DSA) way. Otherwise, when the PUs use the frequency bands, the CUs must promptly withdraw the frequency bands to ensure that PUs can communicate properly without interference from CUs. Typically, the frequency bands will be licensed, but may also be unlicensed or meet other criteria (e.g., “lightly” licensed or shared).

Spectrum sensing (SS) is a fundamental task for cognitive radio systems, and detection statistics plays an essential role in the performance of SS algorithms. Practically, how to pursue an appropriate test statistic is a very challenging issue, because it directly affects the performance of the detection algorithm.

When a blind spectrum sensing is employed in cognitive radio, this type of sensing confronts some technical problems, such as:
There is no information of the noise power and the primary signal in some circumstances.
The sensing method has to have relatively small computation complexity; otherwise the method will increase the cost of the CR device.
The decision threshold for the sensing method has to be robust to the noise uncertainty.
The decision threshold for the sensing method has to be a non-asymptotic expression for any sample size and dimension.

On the other hand, blind sensing is beneficial, as this requires little or no knowledge of PUs and the frequency bands the PUs can use. Therefore, it would be beneficial to provide improved techniques for blind sensing of PUs in CR networks.

### SUMMARY

This section contains examples of possible implementations and is not meant to be limiting.

In an exemplary embodiment, a method includes performing blind spectrum sensing of a frequency band to determine whether a primary user is using the frequency band The blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic. The method includes determining whether to communicate using the frequency band based on whether the blind spectrum sensing indicates the frequency band is or is not used by the primary user.

In another exemplary embodiment, an apparatus includes: means for performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and means for determining whether to communicate using the frequency band based on whether the blind spectrum sensing indicates the frequency band is or is not used by the primary user.

In a further exemplary embodiment, an apparatus includes one or more processors and one or more memories including computer program code. The one or more memories and the computer program code configured, with the one or more processors, to cause the apparatus to perform at least the following: performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and determining whether to communicate using the frequency band based on whether the blind spectrum sensing indicates the frequency band is or is not used by the primary user.

An additional exemplary embodiment is a computer program product. The computer program product comprises a memory bearing computer program code embodied therein for use with a computer. The computer program code comprises: code for performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and code for determining whether to communicate using the frequency band based on whether the blind spectrum sensing indicates the frequency band is or is not used by the primary user.

### BRIEF DESCRIPTION OF THE DRAWINGS

In the attached Drawing Figures:

FIG. 1 is a simplified diagram of various electronic devices in primary and cognitive networks;

FIG. 2 illustrates a simplified block diagram of an exemplary wireless device suitable for use in practicing the exemplary embodiments herein;

FIG. 3 is a block diagram of an exemplary logic flow diagram for blind spectrum sensing based on a maximum correlation coefficient and use thereof, and that illustrates the operation of an exemplary method, a result of execution of computer program instructions embodied on a computer readable memory, and/or functions performed by logic implemented in hardware, in accordance with exemplary embodiments herein;

FIG. 4 is a graph of the statistical distribution of MCC under H₀ and H₁;

FIG. 5 is a graph of ROC performance comparison; and

FIG. 6, including FIGS. 6A, 6B, and 6C, shows performance comparisons of MCC, CAV, MME, MET and CDC methods for different values of N: FIG. 6A uses P_{f}=0.1, M=4, N=50; FIG. 6B uses P_{f}=0.1, M=4, N=100; and FIG. 6C uses Pf=0.1, M=4, N=1024.

### DETAILED DESCRIPTION OF THE DRAWINGS

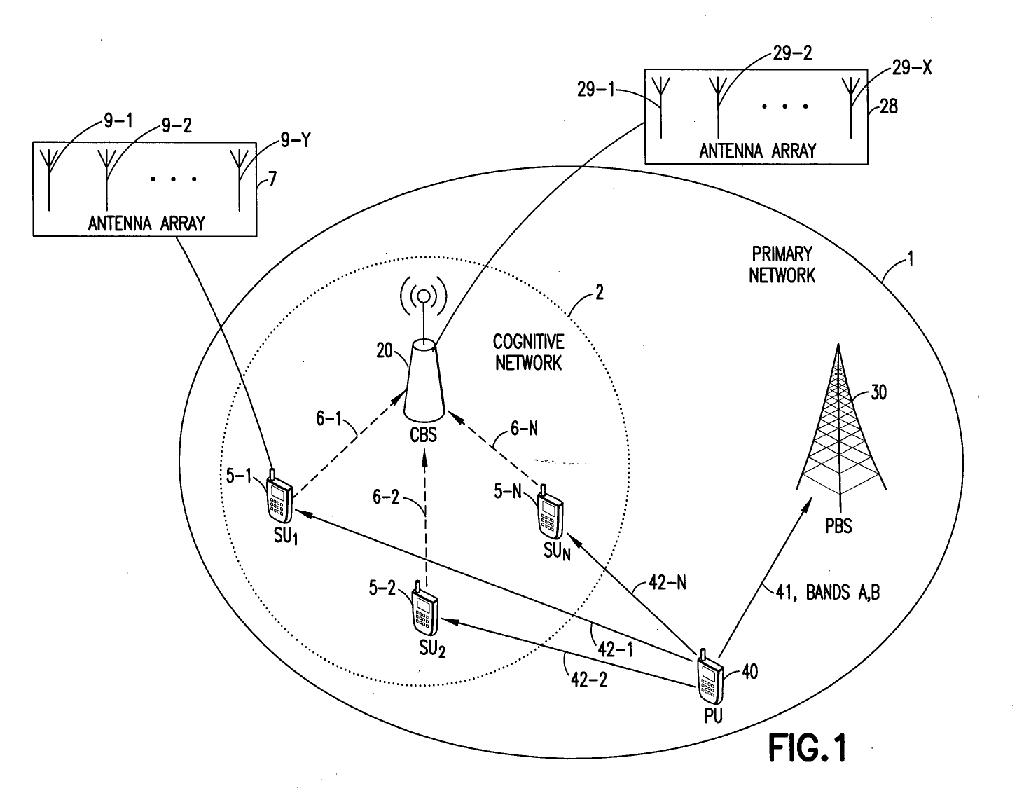

Reference is now made to FIG. 1 for illustrating a simplified diagram of various electronic devices in primary and cognitive networks. The primary network 1 includes the Primary Base Station (PBS) 30 and a wireless device 40 that is a PU. For simplicity, the wireless device will be referred to as a PU 40. The PBS 30 and the PU 40 communicate using one or more frequency bands (e.g., bands A, B) over the wireless link 41. Also shown is a cognitive network 2, which includes wireless devices 5-1, 5-2, . . . , to 5-N, which are SUs of the one or more frequency bands used by the PU 40 and the PBS 30, and a Cognitive Base Station (CBS) 20 (also a secondary user of the one or more frequency bands used by the PU 40 and the PBS 30). For simplicity, the wireless devices will mainly be referred to as SUs 5. Each of the SUs 5 may include an antenna array 7 having multiple antennas (in this example, Y antennas 9). Similarly, the CBS may include a single antenna or an antenna array 28 having multiple antennas (in this example, X antennas 29). The examples below use M antennas, and X or Y or both may be equal to M.

The SUs 5-1, 5-2, . . . , 5-N communicate with the CBS 20 using wireless links 6-1, 6-2, . . . , 6-N, respectively. In an example, the wireless devices 5 can use one or more frequency bands (e.g., band C) not used by the PU 40 to communicate via respective links 6 with the CBS 20. However, when the wireless devices 5 want to use the same one or more frequency bands (bands A and/or B) used by the PU 40 (and therefore be secondary users of the bands A and/or B), the wireless devices 5 have to determine if there is a PU 40 using the bands A and/or B. When the PU 40 communicates with the PBS 30 using one or more frequency bands over the wireless link 41, the PU 40 also causes wireless signals 42-1, 42-2, . . . , 42-N to be generated and received (e.g., as a signal) by corresponding ones of the SUs 5. The SUs 5 can perform spectrum sensing to determine there is a PU 40 that is using the one or more frequency bands (or, conversely, there is no PU 40 that is using the one or more frequency bands).

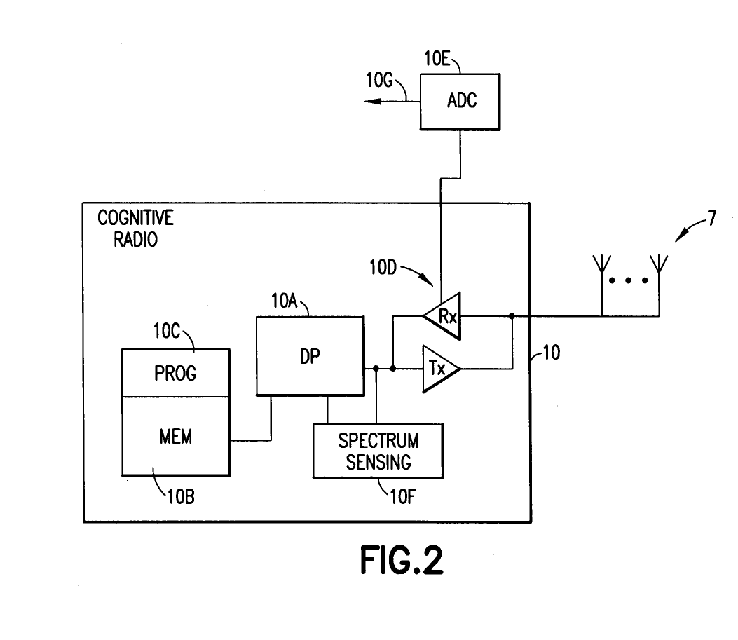

Reference is now made to FIG. 2 for illustrating a simplified block diagram of an exemplary cognitive radio suitable for use in practicing the exemplary embodiments herein. FIG. 2 shows a high level block diagram of a cognitive radio 10, which may be one of the SUs 5 or the CBS 20 from FIG. 1, as examples. The cognitive radio 10 may operate on an opportunistic basis in spectrum bands that are found underutilized by a spectrum sensing functionality. The cognitive radio 10 includes a data processor (DP) 10A, a memory (MEM) 10B that stores a program (PROG) 10C, and a suitable radio frequency (RF) transceiver 10D (with at least one receiver, Rx, and at least one transmitter, Tx) coupled to antenna array 7 for bidirectional wireless communications over one or more wireless links (e.g., wireless links 6 in FIG. 1). The receiver, Rx, includes an Analog to Digital Converter 10E, the output 10G of which may be used in part to determine a snapshot herein. The snapshots typically would be one of the outputs of DP 10A. The MEM 10B may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The DP 10A may be of any type suitable to the local technical environment, and may include one or more of general purpose computers, special purpose computers, microprocessors, digital signal processors (DSPs), ASICs, and processors based on a multicore processor architecture, as non-limiting examples.

A spectrum sensing function 10F is shown, which in various implementations may be embodied as hardware within the receiver portion of the transceiver 10D, as an application specific integrated circuit ASIC (which may be within the transceiver 10D such as an RF front end chip or separate from that chip as illustrated), or within the main DP 10A itself (e.g., as computer-readable program code that is loaded into the DP 10A and executed by the DP 10A and which causes the terminal to perform operations as described herein). Generally, the spectrum sensing functions detailed herein are by the DP 10A/function 10F using the transceiver 10D and antenna array 7 of the CR 10. Once spectrum is sensed and a suitable frequency band is found, the CR 10 may communicate with other CRs such as a CBS 20 or SUs 5. The detection techniques detailed herein are for the CR 10 to sense signals of the primary users 40 which in FIG. 1 are the users on Bands A and B. If the cognitive user determines that there is not a primary user in a frequency band (e.g., at certain times or all the time), that frequency band may be used for communication. In this manner, the cognitive radio 10 can know those portions of the spectrum that the primary users 40 are currently occupying, and tailor the time and frequencies of their own opportunistic communications with other cognitive radios to avoid interfering with those primary users.

For those unfamiliar with the area of SS, a brief introduction is presented at this point, and a more detailed introduction is presented below. Regarding the brief introduction, there are typically two kinds of sensing methods in cognitive radio. One sensing method concerns where the distribution of detection statistic is unknown and one must perform many experiments (such as Monte Carlo experiments) to determine a distribution that can then be used to determine whether a primary user uses (or does not use) a frequency band. The disadvantage of this kind of method is, when a parameter is changed, such as a number of snapshots of the frequency band and a number of antennas in an antenna array, and so on, one must redo the Monte Carlo experiments to determine the new distribution of the detection statistic. Nonetheless, one can determine a detection threshold a CDF of the (new or old) distribution.

The other typical sensing method is where the distribution of a detection statistic is known, such as the method proposed herein. The advantage of this kind of method is, when a parameter is changed, the distribution of the detection statistic can be easily determined through changing those parameters. And one does not need to perform many Monte Carlo experiments to determine the new distribution of the detection statistic.

Regarding a more detailed introduction, in conventional systems for SS, there have been several sensing algorithms such as energy detection, matched filtering and cyclestationary detection, each having different operational requirements, advantages and disadvantages. For example, cyclostationary detection requires knowledge of cyclic frequencies of the primary users, and matched filtering needs to know the waveforms and channels of the primary users. Energy detection does not need any information of the signal to be detected and is robust to unknown dispersive channels. However, energy detection is vulnerable to noise uncertainty.

Some blind sensing methods based on the eigen-values of the covariance matrix of the received signals have been proposed recently, such as the Maximum Minimum Eigen-value (MME) method (see Zeng, et al., ‘Eigenvalue based spectrum sensing algorithms for cognitive radio’, IEEE Trans. Commun., 2009, 57, (6), pp. 1784-1793), Maximum Eigen-value Trace (MET) method (see Zeng, et al, ‘Blindly combined energy detection for spectrum sensing in cognitive radio’, IEEE Signal Process. Lett., 2008, 15, pp. 649-652), the information theoretic method (see Rui, et al, ‘Blind Spectrum Sensing by Information Theoretic Criteria for Cognitive Radios’, IEEE transactions on vehicular technology, 2010, 59, (8), pp. 3806-3817; and Zayen, et al., ‘Blind spectrum sensing for cognitive radio based on model selection’, Proc. 3rd Int. Conf. on CR Oriented Wireless Networks and Communications, May 2008, Singapore, pp. 15-17), and Difference of Maximum Minimum Eigen-value (DMM) method (see Wang Ying-xi, et al., ‘DMM Based Spectrum Sensing Method for Cognitive Radio Systems’, Journal of Electronics & Information Technology, 2010, 32(11), 2572-2574). All of them work well in the case of noise uncertainty, and can even perform better than the ideal ED (that is, with perfect noise power estimate) when the detected signals are highly correlated. These sensing methods belong to the EVD (Eigen-Value-Decomposition) based method. These methods have outstanding performance compared with other algorithms, but they have two drawbacks. Firstly, random matrix theory is used to approximate the real Cumulative Distribution Function (CDF) of methods based on the largest and smallest eigen-values, which is an asymptotic expression of the sample size and dimension. Secondly, those methods suffer from the heavy computational load for the eigen-decomposition.

To deal with these problems, blind sensing methods based on the covariance matrix of the received signals have been proposed recently. The Covariance Absolute Value (CAV) method (see Zeng, et al., ‘Spectrum-sensing algorithms for cognitive radio based on statistical covariances’, IEEE Trans. Veh. Commun., 2009, 58, (4), pp. 1804-1815) only uses the elements of covariance matrix to establish the test statistics. This method reduces the computation complexity, but has the same problem in threshold determination as the EVD based methods. The Cholesky Decomposition of Covariance (CDC) (see Yang, et al., ‘Blind Detection for Primary User Based on the Sample Covariance Matrix in Cognitive Radio’, IEEE communications letters, 2011, 15, (1), pp. 40-42) method gives an exact non-asymptotic threshold, yet this method requires the Cholesky factorization of the sample covariance matrix.

By contrast, in the exemplary embodiments herein, a fast and blind spectrum sensing method is used that is based on the maximum correlation coefficient. A threshold is derived from a distribution function of the maximum correlation coefficient, and such function is a non-asymptotic expression for any sample size and dimension. Simulation and the analytical results demonstrate the effectiveness and robustness of the exemplary embodiments.

As a brief introduction to the exemplary embodiments, if there are M antennas and corresponding signals for the antennas, a number of correlation coefficients is M(M−1)/2. Computations of M(M−1)/2 correlation coefficients are performed for N snapshots of a frequency band. A detection statistic is based on a single maximum correlation coefficient selected from these computations. A CDF of a maximum correlation coefficient may be determined theoretically using M, N, and a t-distribution for correlation coefficients, and a CDF of one correlation coefficient may also be determined theoretically by using N, and a t-distribution corresponding to the correlation coefficient. Statistical analysis may be performed using the CDF of the maximum correlation coefficient and the detection statistic to determine whether it is likely or unlikely that a primary user uses the frequency band. For instance, a comparison may be made between the detection statistic and a threshold determined in part by using the CDF of the maximum correlation coefficient. The comparison indicates whether or not a primary user is using the frequency band.

The exemplary embodiments are different from conventional techniques in aspects such as the following:
The detection statistics are derived from the maximum correlation coefficients, which are important differentiated characteristics between the signal and noise.
The techniques do not require any information of the noise power and the primary signal, hence the techniques belong to the blind methods.
The techniques have less computation complexity, since the techniques do not need to compute the sample covariance matrix and to perform the eigen-value-decomposition (EVD) of sample covariance matrix.
The decision threshold for the techniques is robust to the noise uncertainty and has a non-asymptotic expression for any sample size and dimension.

More detail on the exemplary embodiments is now presented.

Signal Model

Assuming a uniform linear array with M antennas at the CR receiver side, the array output can be expressed as

$$\begin{matrix}X ( k ) = {[ {x}_{1} ( k ) {x}_{2} ( k ) … {x}_{M} ( k ) ]}^{T} \\ = A ( θ ) S ( k ) + N ( k ) \\ = {\sum }_{l = 1}^{p} a ( {θ}_{l} ) {s}_{l} ( k ) + N ( k ) , \\ k = 1 , 2 , … , N\end{matrix} \qquad ( 1 )$$

where A(θ)=[a(θ₁), a(θ₂), . . . , a(θₚ)] is the steering vector of the array, p is the number of the primary user signals (set p=1 since it is assumed that there is only one primary signal in the interested frequency band) and

$$a ( {θ}_{i} ) = {[ 1 , {e}^{j \frac{2 π dsin {θ}_{l}}{λ}} , … , {e}^{j \frac{{2}_{π ( M - 1 ) dsin {θ}_{l}}}{λ}} ]}^{T} ,$$

θ₁ is the direction of primary user signal that impinges on the receiver arrays, d and λ are inter-element spacing of antenna elements 9 in the antenna array 7 and the wavelength (e.g., for the frequency band being examined) respectively, S(k)=[s₁(k), s₂(k), . . . , sₚ(k)]^{T} is the signal vector, N(k)=[n₁(k), n₂(k), . . . , n_{M}(k)]^{T} is the noise vector, superscript T denotes the transpose of a matrix, and N is the number of snapshots (that is, each snapshot being a sample, e.g., from a DP 10 A with input from an ADC 10E according to some sampling frequency). The number of snapshots, N, is determined by many parameters, such as sampling frequency, processing time, P_{d} (probability of detection), P_{f} (probability of false alarm) and the like. Then, the hypothesis testing problem of interest can be expressed as

$$\{ \begin{matrix}{H}_{0} : X ( k ) = N ( k ) \\ {H}_{1} : X ( k ) = A ( θ ) S ( k ) + N ( k )\end{matrix} \qquad ( 2 )$$

where H₀ represents the absence of the PU signal and H₁ represents the presence of the PU signal.

Blind Spectrum Sensing Based on the Maximum Correlation Coefficient

The statistical covariance matrix Σ of received signals is equal to σₙ²I under null hypothesis H₀ and is not a diagonal matrix due to the presence of the primary signal. In other words, the received signals are independent under H₀ and correlated under H₁. So the correlation coefficient, ρ, between the received signals can be used to determine the presence of the primary signal. And the assumption is made that a set of random variables are independent. In an exemplary embodiment, the correlation coefficients are used to test the hypothesis and Eq. (2) changes to

$$\{ \begin{matrix}{H}_{0} : ρ = 0 \\ {H}_{1} : ρ \neq 0\end{matrix} \qquad ( 3 )$$

The correlation coefficient between xᵢ(k) and xⱼ(k) is defined as

$${ρ}_{ij} = \frac{{\sum }_{k = 1}^{N} {x}_{i} ( k ) {x}_{j} ( k ) - N {\overline{x}}_{i} {\overline{x}}_{j}}{\sqrt{{\sum }_{k = 1}^{N} {x}_{i}^{2} ( k ) - N {\overline{x}}_{i}^{2}} \sqrt{{\sum }_{k = 1}^{N} {x}_{j}^{2} ( k ) - N {\overline{x}}_{j}^{2}}} , \qquad ( 4 )$$

where xᵢ (k) is the i-th component of X and

$${\overline{x}}_{i} = \frac{1}{N} {\sum }_{k = 1}^{N} {x}_{i} ( k ) . \qquad ( 5 )$$

From Eqs. (4) and (5), it is clear that the measure of association is symmetric in xᵢ(k) and xⱼ(k), ρᵢⱼ=ρⱼᵢ. And the correlation coefficient is dependent on the variances and covariance of xᵢ(k) and xⱼ(k) So equation (4) can be rewritten as follows:

$${ρ}_{ij} = \frac{{σ}_{ij}}{\sqrt{{σ}_{ii}} \sqrt{{σ}_{jj}}} , \qquad ( 6 )$$

where σᵢᵢ and σⱼⱼ are the variances of xᵢ (k) and xⱼ(k), respectively, and σᵢⱼ is the covariance of xᵢ (k) and xⱼ (k).

From Anderson, T W, “An introduction to multivariate statistical analysis” (New York Press, 1957, and ed. 2003), random variable \sqrt{N−2}ρᵢⱼ/\sqrt{1−ρᵢⱼ²} has a t-distribution with N−2 degrees of freedom. The receiver has M antennas independently in total, so the number of correlation coefficients is M(M−1)/2.

Now consider the case of n random variables, X₁, X₂, . . . Xₙ (n=M(M−1)/2), where each random variable is \sqrt{N−2}ρᵢⱼ/\sqrt{1−ρᵢⱼ²} (and thus has a t-distribution) for one of the M(M−1)/2 correlation coefficients. The cumulative distribution function (CDF), for real number z, is

$$\begin{matrix}{F}_{max} ( z ) = P \{ {X}_{1} \leq z , {X}_{2} \leq z , … , {X}_{n} \leq z \} \\ = {F}_{{X}_{1}} ( z ) {F}_{{X}_{2}} ( z ) … {F}_{{X}_{n}} ( z ) \\ = {[ F ( z ) ]}^{n} .\end{matrix} \qquad ( 7 )$$

It is noted that F(z) is a CDF for one correlation coefficient (one of the ρᵢⱼ) for N snapshots. The CDF, Fₘₐₓ(z), for the maximum correlation coefficient is then calculated as above in Eq. (7). And, correspondingly, the probability density function (PDF) is

$${f}_{max} ( z ) = \frac{d {F}_{max} ( z )}{d z} = {n [ F ( z ) ]}^{n - 1} f ( z ) . \qquad ( 8 )$$

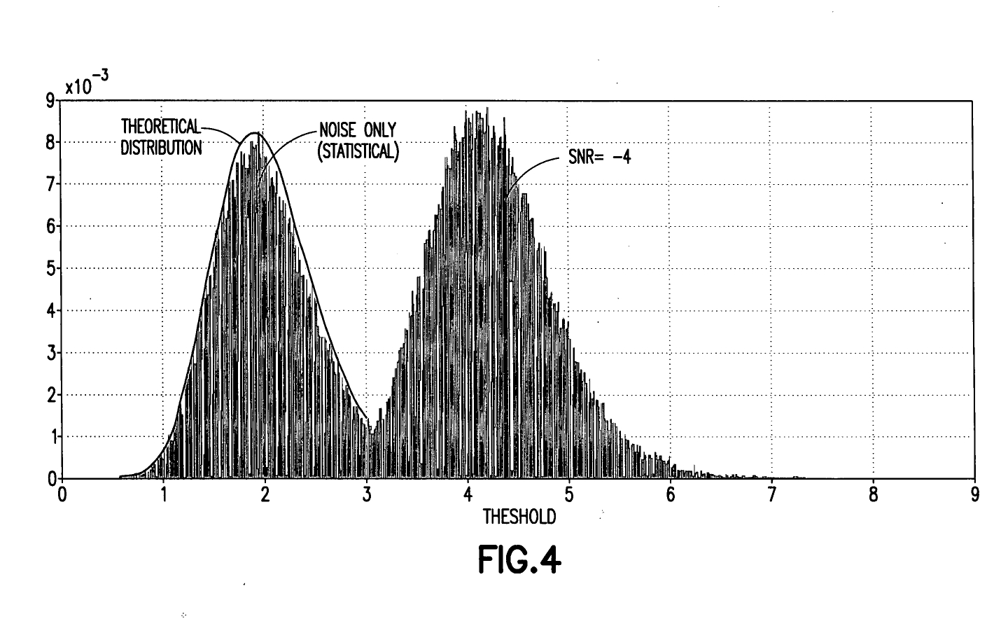

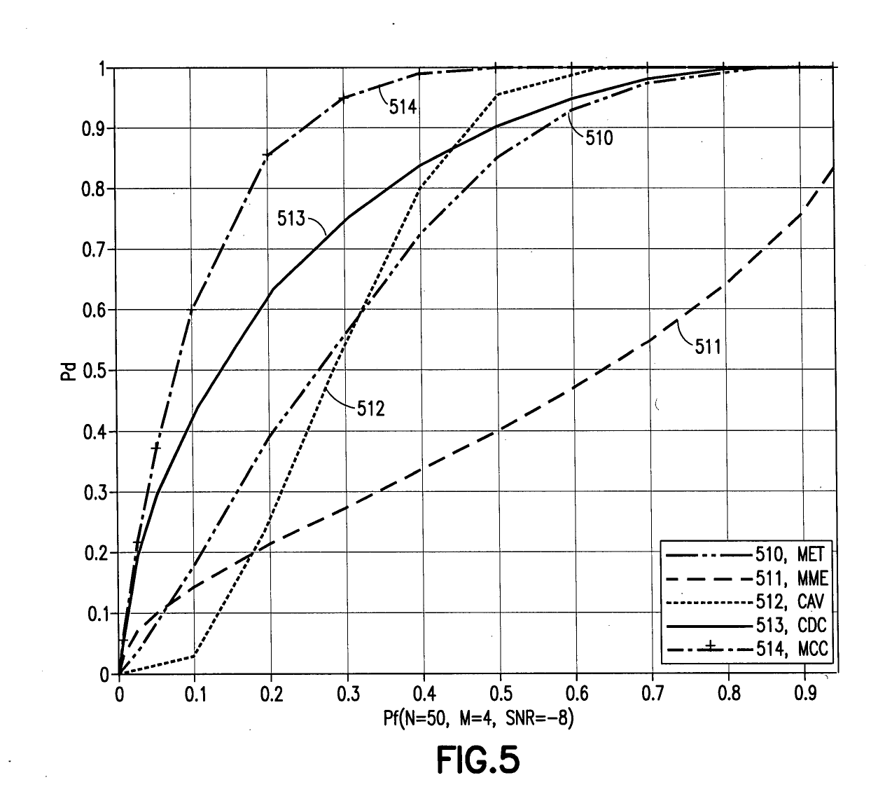

It is noted that the PDF may be determined and used to demonstrate (as described below) that a theoretical distribution coincides with a statistical distribution. See FIG. 4. The following detection statistic is introduced (where “max( )” selects a maximum value):

$${T}_{MCC} = {max}_{1 \leq i < j \leq M} ( \sqrt{N - 2} \frac{\vert {ρ}_{ij} \vert}{\sqrt{1 - {ρ}_{ij}^{2}}} ) . \qquad ( 9 )$$

The critical region of the likelihood ratio test is

T_{MCC}<T_{MCC}(α), (10)

where T_{MCC}(α) is a number such that the probability of Eq. (10) is α under H₀.

Under H₀, the correlation ρᵢⱼ=0, so detection statistics are close to 0. The threshold γ_{MCC}=0 for a given false-alarm probability P_{f} can then be determined by combining

$$\begin{matrix}{P}_{f} = 1 - {F}_{{T}_{MCC}} ( {γ}_{MCC} ) = 1 - {F}^{n} ( {γ}_{MCC} ) , \\ So & ( 11 ) \\ {γ}_{MCC} = {F}_{t}^{- 1} [ {( 1 - {P}_{f} )}^{\frac{1}{n}} ] , & ( 12 )\end{matrix}$$

where Fₜ⁻¹() is the inverse function of a t-distribution CDF, where the where the CDF is F(z) from Eq. (7) for one correlation coefficient.

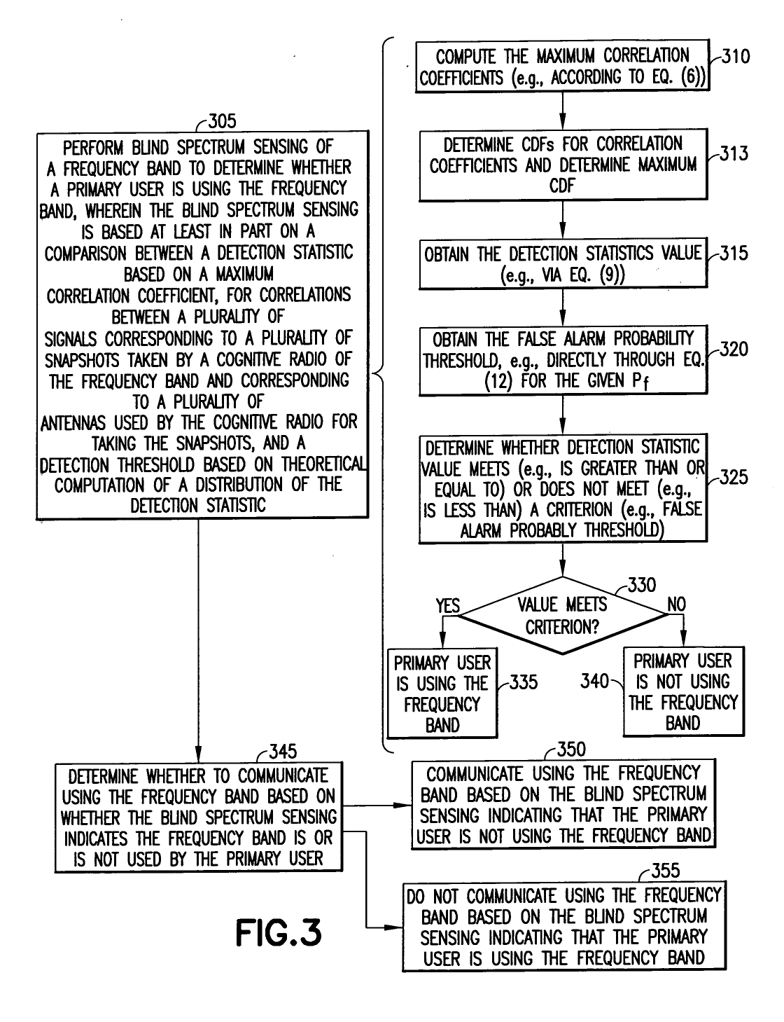

Based on the above analysis, the Maximum Correlation Coefficient (MCC) algorithm with a novel detection statistic can be given as follows. Turning now to FIG. 3, this figure is a block diagram of an exemplary logic flow diagram for blind spectrum sensing based on maximum correlation coefficients and use thereof. This figure also illustrates the operation of an exemplary method, a result of execution of computer program instructions embodied on a computer readable memory, and/or functions performed by logic implemented in hardware, in accordance with exemplary embodiments herein. The blocks in FIG. 3 may be considered to be interconnected means for their corresponding functions. The blocks in FIG. 3 may be caused by the spectrum sensing tool 10F, which causes the cognitive radio 10 to perform the operations in the blocks of FIG. 3. For simplicity, it is assumed that the cognitive radio 10 (e.g., under direction of the spectrum sensing tool 10F) performs the operations in the blocks of FIG. 3.

In block 305, the cognitive radio 10 performs blind spectrum sensing of a frequency band to determine whether a primary user is using the frequency band. The blind spectrum sensing is based at least in part on a comparison between a detection statistic and a detection threshold. The detection statistic is based on a maximum correlation coefficient, for correlations between a plurality of signals corresponding to a plurality of snapshots taken by a cognitive radio of the frequency band and corresponding to a plurality of antennas used by the cognitive radio for taking the snapshots. The detection threshold is based on theoretical computations of a distribution of the detection statistic. Block 305 may include blocks 310-340.

In block 310, the correlation coefficients are computed, e.g., according to Eq. (6). The computations in Eq. (6) are performed for the M(M−1)/2 correlation coefficients (e.g., for each two signals for two antennas of the antenna array 7) and for N snapshots of a frequency band. That is, Eq. 6 is used to determine a set of correlation coefficients, and a maximum one of the set may be found. Note that block 310 is performed by a CR 10 by sampling a frequency band to determine the N snapshots and signals for the M antennas.

In block 313, the CDF for one of the correlation coefficient (one of the ρᵢⱼ), that is, F(z), for N snapshots is determined. Using these CDFs, the CDF, Fₘₐₓ(z), of the maximum correlation coefficient is then calculated as above in Eq. (7), e.g., using a single CDF because the M(M−1)/2 CDFs are all the same in accordance with Eq. (7). Note that block 313 is performed theoretically, e.g., using simulated information based on M, N, and a t-distribution of a correlation coefficient.

In block 315, the detection statistics value is obtained (e.g., computed), e.g., via Eq. (9). Note that block 315 is determined by a CR 10 using actual data sampled from a frequency band. In block 320, the detection threshold γ_{MCC} is obtained (e.g., computed) directly through Eq. (12) for the given P_{f}. P_{f} is chosen according to system requirements and once the P_{f} is chosen, the larger P_{d} is, the better the performance of the system is. Note that computation of Eq. (12) uses the CDF for the maximum correlation coefficient determined in Eq. (7), and therefore computations using Eq. (12) are performed theoretically. It is noted because Eq. (7) and Eq. (12) are computed theoretically, they (and blocks 313 and 320) may be computed offline (that is, before a CR 10 would use these and perform, e.g., blocks 310 and 315). It is also noted that these may be computed theoretically for many different combinations of M and N, so that they may be used by different cognitive radios 10 with different antenna and snapshot requirements. It should be noted that the N used by a CR 10 and the Nused for Eq. (7) and Eq. (12) should be the same.

In block 325, the cognitive radio 10 determines whether the detection static value meets (e.g., is greater than or equal to) or does not meet (e.g., is less than) a criterion. The criterion in an exemplary embodiment is the detection threshold γ_{MCC}, which is the false alarm probably threshold described above. Block 325 can be considered to make the MCC decision, that is, when T_{MCC}≧γ_{MCC}, the primary signal exists; when T_{MCC}<γ_{MCC}, the primary signal does not exist. That is, in block 330, it is determined whether the detection statistics value meets the criterion. If the value meets the criterion (e.g., T_{MCC}≧γ_{MCC}) (block 330=Yes), the cognitive radio 10 determines the primary user is using the frequency band (block 335). If the value does not meet the criterion (e.g., T_{MCC}<γ_{MCC}) (block 330=No), the cognitive radio 10 determines the primary user is not using the frequency band (block 340).

In block 345, the cognitive radio 10 determines whether to communicate using the frequency band based on whether the blind spectrum sensing indicates the frequency band is or is not used by the primary user. It is noted that the process could stop at this point, e.g., so that another frequency band can be examined. Many such frequency bands can be examined and information gathered regarding whether primary users are or are not found using the frequency bands. At some point, it is expected that the cognitive radio 10 would use or not use a selected frequency band to communicate. Thus, in block 350, the cognitive radio 10 communicates using the frequency band based on the blind spectrum sensing indicating that the primary user is not using the frequency band. In block 355, the cognitive radio 10 does not communicate using the frequency band based on the blind spectrum sensing indicating that the primary user is using the frequency band.

It is noted that the analysis of FIG. 3 may be improved upon by the cognitive radio 10 using block 305 for multiple times during, e.g., a course of a day. Then, the cognitive radio 10 may be able to determine that a primary user is using a frequency band during certain times of the day but not during other times of the day. The analysis may also be performed for days during the week (e.g., for weekends, the primary user does not use the frequency band or lightly uses the frequency band). Additionally, the analysis of FIG. 3 may be used for multiple frequency bands.

The exemplary embodiments offer such non-limiting and exemplary advantages as follows:

1) The method can work well in small sample observations and small dimension size.

2) The method does not need to compute the covariance matrix and perform the Cholesky factorization, and thus the computation complexity is greatly reduced.

3) The decision threshold for this invention is robust to the noise uncertainty, because the correlation coefficient is normalized according to the power of channels from Eqs. (4) and (6).

4) The decision threshold has a non-asymptotic expression for any sample size and dimension, the distribution of T_{MCC} is varied with different N (e.g., snapshots) and M (e.g., dimensions).

To demonstrate the performance of the MCC algorithm, simulations with M=4 and 100,000 Monte-Carlo experiments were carried out. FIG. 4 shows the statistical distribution of the exemplary method herein under H₀ and H₁. In the left part of the figure, it is the distribution under H₀. It can be seen that the theoretical distribution coincides with statistical distribution. In the right part of the figure, it is the distribution of noisy signal with SNR=−4 dB, which separate well with that of H₀ situation. There is of great discrimination to a primary user signal.

FIG. 5 shows the ROC performance comparison of the instant MCC detector, CAV detector, MME detector, MET detector, CDC detector. The number of snapshots, N, is 50, there are four (M=4) antennas, and the SNR is −8 dB. P_{d} is the probability of detection. It is clear that the MCC detector performs better under the limited sample observations.

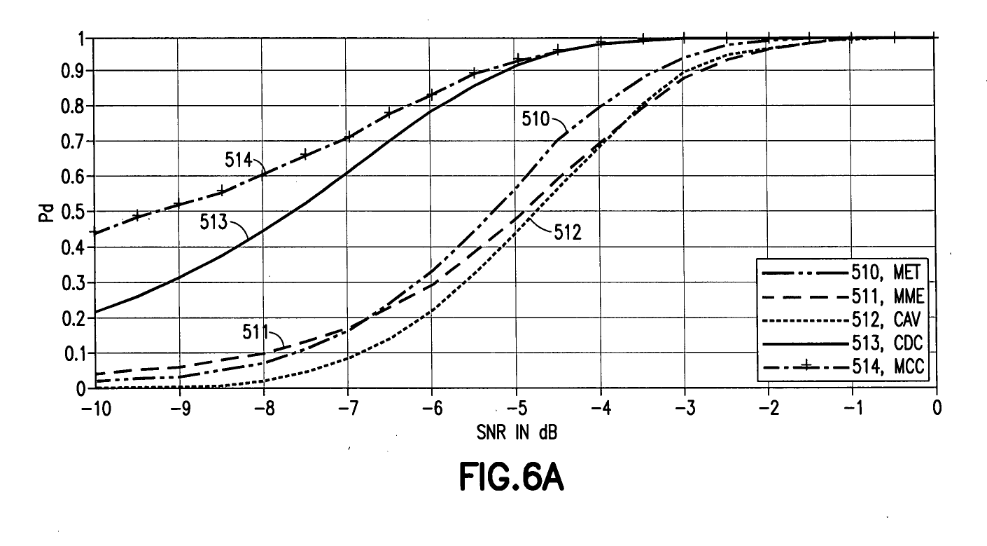

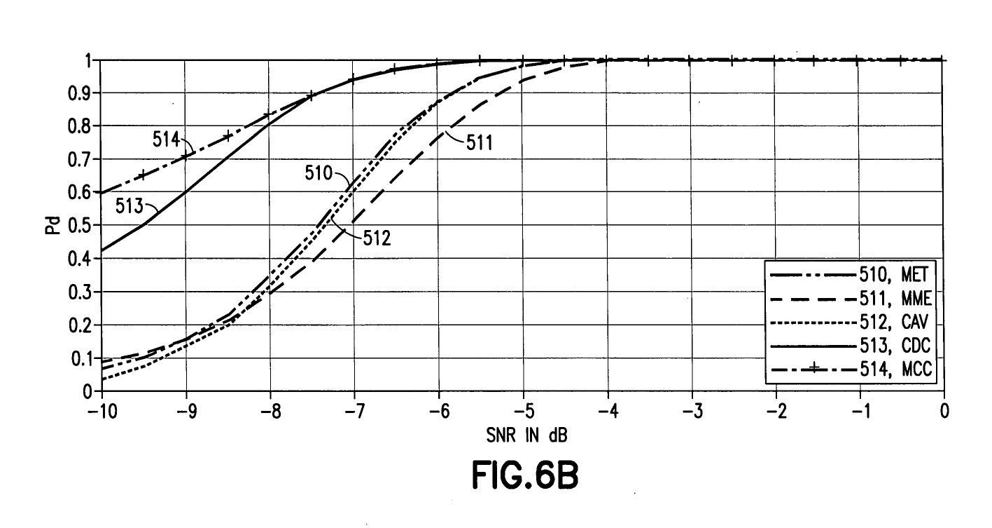

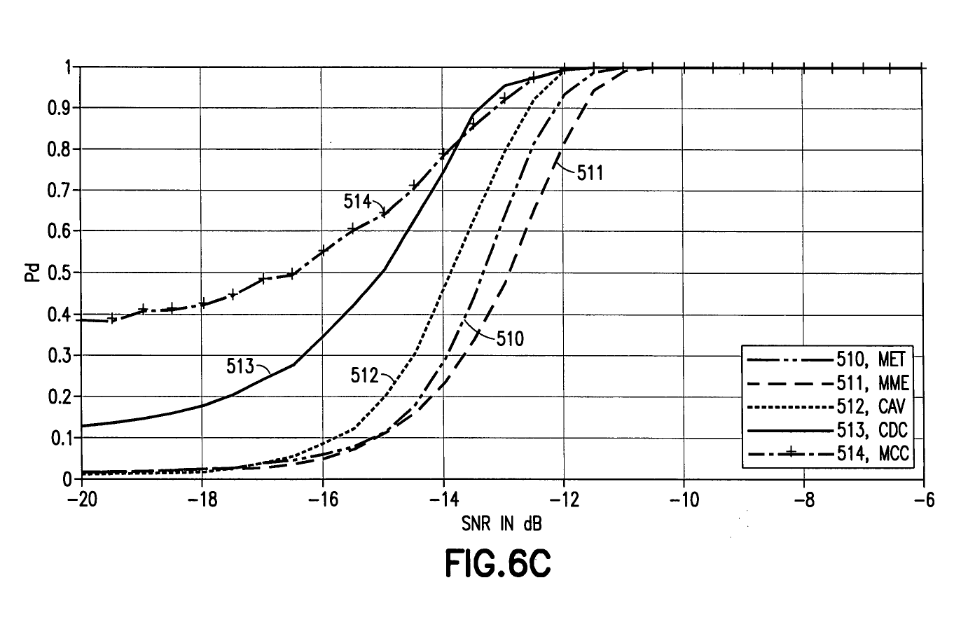

FIG. 6, including FIGS. 6A, 6B, and 6C, shows the performance comparison of MCC, CAV, MME, MET and CDC detectors for P_{f}=0.10 and N=50 (FIG. 6A), N=100 (FIG. 6B) and N=1024 (FIG. 6C) separately (and also M=4). It is clear that MCC detector performs better than the CAV, MME, MET in the small P_{f} region irrespective of the sample size. The MCC detector even performs better than the CDC detector in small samples situation and little worse in large samples but still in the promised probability region. Moreover, the MCC detector does not need to perform the Cholesky factorization and the computation complexity is greatly reduced.

Without in any way limiting the scope, interpretation, or application of the claims appearing below, a technical effect of one or more of the example embodiments disclosed herein is to allow blind spectrum sensing to be performed of a frequency band to determine whether a primary user is using the frequency band, wherein the blind spectrum sensing is based at least in part on computation of one or more maximum correlation coefficients. Another technical effect is to allow a cognitive radio to determine whether a primary user is using the frequency band. A further technical effect is to allow the cognitive radio to use the frequency band in response to a determination the primary user is not using the frequency band or to not use the frequency band in response to a determination the primary user is using the frequency band.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory(ies) 10B or other device) that may be any media or means that can contain or store the instructions for use by or in connection with an instruction execution system, apparatus, or device, such as a computer. It is noted that a computer-readable storage medium does not encompass propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
ADC Analog-to-Digital Converter
ASIC Application Specific Integrated Circuit
CAV Covariance Absolute Value
CBS Cognitive Base Station
CDC Cholesky Decomposition of Covariance
CDF Cumulative Distribution Function
CR Cognitive Radio
CRN Cognitive Radio Network
CUs Cognitive User
DMM Difference of Maximum Minimum Eigen-value
DSA Dynamic Spectrum Access
ED Energy Detection
Eq. Equation
Eqs. Equations
EVD Eigen-Value-Decomposition
MCC Maximum Correlation Coefficient
MET Maximum Eigen-value Trace
MME Maximum Minimum Eigen-value
PBS Primary Base Station
PUs Primary Users
RF Radio Frequency
ROC Receiver Operating Characteristic
SNR Signal-to-Noise Ratio
SS Spectrum Sensing

What is claimed is:

1. A method, comprising:
performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and
determining whether to communicate using the frequency band based on whether the blind spectrum sensing indicates the frequency band is or is not used by the primary user.

2. The method of claim 1, further comprising communicating using the frequency band based on the blind spectrum sensing indicating that the primary user is not using the frequency band.

3. The method of claim 1, further comprising not communicating using the frequency band based on the blind spectrum sensing indicating that the primary user is using the frequency band.

4. The method of claim 1, wherein performing blind spectrum sensing further comprises computing the detection statistic at least by computing a plurality of correlation coefficients, wherein each of the plurality of correlation coefficients is determined using a covariance between any two of the plurality of signals, a variance for one of the two signals and a variance for the other one of the two signals, and wherein each signal corresponds to a unique one of the plurality of antennas.

5. The method of claim 4, wherein computing the plurality of correlation coefficients comprises computing
$${ρ}_{ij} = \frac{{σ}_{ij}}{\sqrt{{σ}_{ii}} \sqrt{{σ}_{jj}}} ,$$
where ρᵢⱼ is a correlation coefficient for one (i) signal for one of the plurality of antennas and the other (j) signal for another of the plurality of antennas, σᵢⱼ is a covariance for the two signals, σᵢᵢ is a variance for the one signal, and σⱼⱼ is a variance for the other signal.

6. The method of claim 4, wherein performing blind spectrum sensing further comprises computing the detection statistic based on the correlation coefficients.

7. The method of claim 6, wherein computing the detection statistic based on the maximum correlation coefficients further comprises computing
$${T}_{MCC} = {max}_{1 \leq i < j \leq M} ( \sqrt{N - 2} \frac{\vert {ρ}_{ij} \vert}{\sqrt{1 - {ρ}_{ij}^{2}}} ) ,$$
wherein T_{MCC} is the detection statistic, N is a number of the plurality of snapshots, ρᵢⱼ is a correlation coefficient for the one (i) signal and the other (j) signal, and M is a number of the plurality of antennas.

8. The method of claim 6, wherein the detection threshold is a false alarm probability threshold that is determined theoretically based on theoretical computation of the distribution of the detection statistic and is determined prior to performing the blind spectrum sensing, and wherein the false alarm probability threshold is determined based on a given false alarm probability.

9. The method of claim 8, wherein the false alarm probability threshold is determined theoretically by computing
$${γ}_{MCC} = {F}_{i}^{- 1} [ {( 1 - {P}_{f} )}^{\frac{1}{n}} ] ,$$
wherein γ_{MCC} is the false alarm probability threshold, Fₜ⁻¹ () is an inverse function of a t-distribution cumulative distribution function of one of the correlation coefficients, P_{f} is the given false alarm probability, and n=M (M−1)/2, and wherein the t-distribution cumulative distribution function of one of the correlation coefficients is determined theoretically and prior to performing the blind spectrum sensing.

10. The method of claim 8, wherein blind spectrum sensing further comprises determining whether the primary user is using the frequency band by determining whether the detection statistic meets a criterion using the false alarm probability threshold.

11. The method of claim 10, wherein determining whether the detection statistic meets a criterion using the false alarm probability threshold further comprises determining the detection statistic meets the criterion in response to the detection statistic being greater than or equal to the false alarm probability threshold or determining the detection statistic does not meets the criterion in response to the detection statistic being less the false alarm probability threshold.

12. An apparatus, comprising:
one or more processors; and
one or more memories including computer program code,
the one or more memories and the computer program code configured, with the one or more processors, to cause the apparatus to perform at least the following:
performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and
determining whether to communicate using the frequency band based on whether the blind spectrum sensing indicates the frequency band is or is not used by the primary user.

13. The apparatus of claim 12, wherein the one or more memories and the computer program code are further configured, with the one or more processors, to cause the apparatus to perform at least the following: communicating using the frequency band based on the blind spectrum sensing indicating that the primary user is not using the frequency band.

14. The apparatus of claim 12, wherein the one or more memories and the computer program code are further configured, with the one or more processors, to cause the apparatus to perform at least the following: not communicating using the frequency band based on the blind spectrum sensing indicating that the primary user is using the frequency band.

15. The apparatus of claim 12, wherein performing blind spectrum sensing further comprises computing the detection statistic at least by computing a plurality of correlation coefficients, wherein each of the plurality of correlation coefficients is determined using a covariance between any two of the plurality of signals, a variance for one of the two signals and a variance for the other one of the two signals, and wherein each signal corresponds to a unique one of the plurality of antennas.

16. The apparatus of claim 15, wherein computing the plurality of correlation coefficients comprises computing
$${ρ}_{ij} = \frac{{σ}_{ij}}{\sqrt{{σ}_{ii}} \sqrt{{σ}_{jj}}} ,$$
where ρᵢⱼ is a correlation coefficient for one (i) signal for one of the plurality of antennas and the other (j) signal for another of the plurality of antennas, σᵢⱼ is a covariance for the two signals, σᵢᵢ is a variance for the one signal, and σⱼⱼ is a variance for the other signal.

17. The apparatus of claim 16, wherein performing blind spectrum sensing further comprises computing the detection statistic based on the correlation coefficients.

18. The apparatus of claim 17, wherein computing the detection statistic based on the maximum correlation coefficients further comprises computing
$${T}_{MCC} = {max}_{1 \leq i < j \leq M} ( \sqrt{N - 2} \frac{\vert {ρ}_{ij} \vert}{\sqrt{1 - {ρ}_{ij}^{2}}} ) ,$$
wherein T_{MCC} is the detection statistic, N is a number of the plurality of snapshots, ρᵢⱼ is a correlation coefficient for the one (i) signal and the other (j) signal, and M is a number of the plurality of antennas.

19. The apparatus of claim 17, wherein the detection threshold is a false alarm probability threshold that is determined theoretically based on theoretical computation of the distribution of the detection statistic and is determined prior to performing the blind spectrum sensing, and wherein the false alarm probability threshold is determined based on a given false alarm probability.

20. A computer program product comprising a memory bearing computer program code embodied therein for use with a computer, the computer program code comprising:
code for performing blind spectrum sensing of a frequency band to determine whether a primary user is using the frequency band, wherein the blind spectrum sensing is based at least in part on a comparison between a detection statistic based on a maximum correlation coefficient, for correlations between a plurality of signals corresponding to a plurality of snapshots taken by a cognitive radio of the frequency band and corresponding to a plurality of antennas used by the cognitive radio for taking the snapshots, and a detection threshold based on theoretical computation of a distribution of the detection statistic; and
code for determining whether to communicate using the frequency band based on whether the blind spectrum sensing indicates the frequency band is or is not used by the primary user.
